(19) United States
(12) Patent Application Publication
(10) Pub. No.: US 2014/0272542 A1
(43) Pub. Date: Sep. 18, 2014

(54) ELECTROCHEMICAL ENERGY STORAGE DEVICE WITH MOLECULAR SEIVE STORAGE CELL

(71) Applicant: COOPER TECHNOLOGIES COMPANY, (US)

(72) Inventor: Cyrus Sam Rustomji, Walnut Creek, CA (US)

(73) Assignee: COOPER TECHNOLOGIES COMPANY, Houston, TX (US)

(21) Appl. No.: 13/795,113

(22) Filed: Mar. 12, 2013

(51) Int. Cl. H01G 11/54; H01M 2/14; H01G 13/04; H01M 2/16; H01M 2/02

(52) U.S. Cl. CPC H01G 11/54; H01M 2/16; H01M 2/0212; H01G 13/04; H01M 2/145
USPC 429/162; 361/502; 429/247; 429/163; 29/25.03; 29/623.2; 29/623.5

(57) ABSTRACT

Energy storage devices including at least one energy storage cell having molecular sieves to mitigate a sensitivity of the storage cell to water contamination that may degrade performance of an electrolyte associated with the energy storage cell.

### BACKGROUND OF THE INVENTION

The field of the invention relates generally to the manufacture of electrochemical energy storage devices, including but not limited to electric double layer capacitor (EDLC) devices, and more specifically to.

In electrical systems, secondary sources of current make it possible to accumulate, store and release electrical power to an external electric circuit. Among these secondary sources are conventional energy storage devices such as batteries, conventional capacitors and electrochemical capacitors.

One type of electrochemical capacitor is an electric double layer capacitor (EDLC) device that may sometimes be referred to as a supercapacitor. Supercapacitors typically have specific capacitance of greater than 100 F/g, as opposed to conventional capacitors with specific capacitance on the order of only several F/g. Supercapacitors are used in a variety of different applications, including but not limited to memory backup to bridge short power interruptions, battery management applications to improve the current handling of a battery or to provide a current boost on high load demands, fuel cell applications to enhance peak-load performance, regenerative braking on vehicles, and vehicle starting systems.

An electrochemical supercapacitor conventionally includes a sealed housing filled with an electrolyte, a positive electrode (cathode) and a negative electrode (anode) placed inside the housing, a separator such as a membrane that separates the anode space from the cathode space, and special lead terminals coupling the supercapacitor to external electric circuits. Manufacturing difficulties and voltage limitations exist in known supercapacitor constructions, and improvements are desired.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a flowchart of an exemplary method for manufacturing an electrochemical energy storage device.

FIG. 2 is a perspective view of a first exemplary energy storage device manufacturable according to the method shown in FIG. 1.

FIG. 3 is a flowchart of an exemplary method for manufacturing the device shown in FIG. 2.

FIG. 4 is a perspective view of a second exemplary energy storage device manufacturable according to the method shown in FIG. 1.

FIG. 5 is a sectional view of the EDLC device shown in FIG. 4.

FIG. 6 is a sectional view of a second exemplary energy storage device manufacturable according to the method shown in FIG. 1.

FIG. 7 is a perspective view of the EDLC device shown in FIG. 6.

FIG. 8 is a sectional of a fourth exemplary embodiment of an EDLC device manufacturable according to the method shown in FIG. 1.

### DETAILED DESCRIPTION OF THE INVENTION

Exemplary embodiments of an improved electrode manufacture for electrochemical energy storage devices, as well as electrochemical energy storage devices having such improved electrodes, are described hereinbelow that overcome certain disadvantages in the art.

From a manufacturing perspective, the fabrication of energy storage cells included in devices such as EDLCs and battery devices has conventionally been difficult. Since water is detrimental to cell performance, the electrolyte utilized in the cells is conventionally carefully manufactured, and only the driest, purest solvents and salts are used. This, however, typically entails careful processing and additional cost for the manufacture of such devices. Indeed, the electrolyte is one of the most expensive components to each of the storage cells of the device.

Electrolyte suppliers for conventional EDLC devices generally spec their electrolyte at 10-100 ppm water. The electrolyte is accordingly conventionally stored in an air tight manner after its manufacture. During manufacture of energy storage devices the electrodes are conventionally carefully dried prior to introducing the electrolyte to the device in a vacuum. The electrolyte addition to the storage cell(s) is conventionally performed in a dry room environment to avoid further water contamination, and the sealing of the storage cells and completion of the devices are also performed in a dry room. Alternatively, electrolyte addition is performed in a glove box. Running and maintaining the dry room environment, however, contributes significant cost and expense to fabricating the EDLC devices, and if the dry room environment is compromised, lengthy delays and manufacturing down time may result until the dry room environment can be restored. Glove boxes present other difficulties in completing process steps in the manufacture and are therefore not a desirable alternative to dry rooms.

Despite concerted efforts to control water contamination issues during EDLC manufacturing operations, electrolyte can and does inadvertently become contaminated with excessive amounts of water as such devices are manufactured, even if the electrolyte itself is carefully handled and controlled. For example, an incompletely dried electrode may compromise the electrolyte at a later point in time. As a result, cell performance of the EDLC device can be negatively impacted, sometimes to unacceptable levels. Reliability issues and unacceptable performance variations in otherwise similar EDLC devices may also undesirably result in a rather unpredictable manner in the fabrication of such EDLC devices, and thus can be difficult to detect and/or correct in real time as the devices are being fabricated, contributing to lengthy production delays as some investigation may be required to trace the source of electrolyte contamination before corrective action can be taken.

An improved electrode manufacture, as well as energy storage device manufacture, is accordingly described below that effectively solve these and other longstanding problems in the art. Such improvements are facilitated at least in part with molecular sieves in the construction of the storage cells, which mitigates problematic water contamination of electrolyte that may degrade performance of the storage cells. By virtue of the molecular sieves in the energy storage cells, electrochemical energy storage devices may be fabricated in less time and with less cost, while improving manufacturing yields and providing longer life and improved performance.

For the purposes of the present description, molecular sieves are materials with very narrow pore size distribution, and are often used as an absorbent of liquids or gasses. As such, when implemented in an EDLC storage cell fabrication process, a molecular sieve of an appropriate pore size will only allow passage of water and not the electrolyte carrying solvent (typically an organic solvent) or salt. For example, a molecular sieve of pore size 3 angstroms would be considered an appropriate pore size for water absorption but not larger organic molecules, and hence would be suitable to incorporate into the electrodes. Other pore size sieves, however, both greater and smaller, could be used in other embodiments with different types of electrolytes. It is also noted that different pore sizes may also absorb other contaminants in addition to water.

With such an addition of molecular sieves into an energy storage cell, additional drying of electrolyte will occur throughout life of the cell, but initial water absorption would be strongest. Since molecular sieves are not electronically conducting, water that has been absorbed cannot perform in electrochemical reactions, thereby extending the life of the energy storage cell and retaining good performance of the associated energy storage device such as those described further below or other types of energy storage devices familiar to those in the art. Because the molecular sieves can absorb some amount of water, the devices and manufacturing operations are not as sensitive to water contamination issues as conventional components have been. Cost savings may therefore be realized for devices including the molecular sieves by reducing costs of running and maintaining dry rooms for the manufacture of the devices and/or avoiding glove boxes, allowing for lower cost electrolytes to be used, facilitating a shorter drying time for component parts of the devices, and avoiding manufacturing down time attributable to water contamination issues.

An exemplary method or process 50 of manufacturing an energy storage device such as an ELDC device or a storage battery is shown in FIG. 1.

In general, molecular sieves of any appropriate size may be added to an energy storage cell during any processing step, but in contemplated embodiments, and as shown in FIG. 1, the molecular sieve is added and mixed with the electrode materials to simplify processing. A molecular sieve powder of small diameter, comparable to the diameter of other electrode components, is preferred but not required.

As shown in FIG. 1, an electrode slurry is provided at exemplary step 52. Optionally, and as shown in FIG. 1, the slurry may be obtained by adding activated carbon to water, and mixing the result as shown at step 54.

Conducting carbon may then be added to the mixture as shown at step 56 and the result is again mixed.

As shown at step 58 a binder is added, and the result is again mixed.

Finally, the molecular sieve is added to the result as shown at step 60, and the result is again mixed. In one example, the molecular sieve may be a 3 angstrom, 600 mesh powder sieve commercially available from Strem Chemicals, Inc. of Newburyport, Mass.

As shown at exemplary step 62, the slurry provided at step 52 is dried at, for example, 110° C. for a predetermined amount of time to obtain a powder. The composition of the powder, in one example, is more than 60% of activated carbon by solid weight, less than 20% of conductive carbon by solid weight, more than 1% binder by solid weight, and less than 5% molecular sieve by solid weight. Other variations of the composition are possible, however, in other embodiments. That is, different amounts of activated carbon, conductive carbon, binder and molecular sieve may be used as necessary or desired. Other elements in the composition, or equivalents of those described, are possible as well, in addition to or in lieu of the exemplary composition described above.

The powder obtained at step 62 is then compressed as shown at step 64 through a two-mill roll, for example, to create a sheet of electrode material. Electrodes of appropriate shape and dimensions are then stamped from the sheet as shown at step 66. By creating the sheets of electrode material, bulk manufacturing processes are facilitated, although in some embodiments the formation of the sheets may be considered optional and may be omitted. For example, the powder may be formed into electrodes by a molding step or other known techniques in lieu of stamping the electrodes from sheets of material if desired.

Once the electrodes including the molecular sieves are formed at step 66, the electrodes may be utilized to assemble storage cells as shown at step 68. The storage cells may be configured as shown as described below in relation to the devices 80, 120, 200 and 300 of FIGS. 2 and 4-8. Single storage cells may be assembled for a device, or multiple storage cells may be provided for a device. To provide a single storage cell device, first and second electrodes may be assembled with a separator as shown in, for example, the device 80 of FIG. 2. To provide a dual cell device, first and second electrodes are assembled with a first separator and third and fourth electrodes are assembled with a second separator as shown, for example, in the devices 120 and 200 of FIGS. 4-5 and 6-7, respectively. Still further storage cells could be provided in a similar manner if desired.

In still other embodiments, the storage cell assembled at step 68 may be provided as a generally tubular or cylindrical jelly roll having multiple layers (electrode layers and separator layers) that define a single cell or multiple cells as shown in the device 400 of FIG. 8. It is recognized that in lieu of a cylindrical jelly roll, other shapes and configurations of storage cells are possible, including but not limited to folded configurations and accordion shapes if desired.

As shown at step 70, the electrolyte is added to the storage cells, typically after the storage cells are assembled at least partially in a housing, although in some embodiments it may be possible to add the electrolyte prior to assembly with the housing. At step 72, the housing of the device is sealed in a known manner. The housing may include the housings described in relation to the devices 80 (FIG. 2), 120 (FIGS. 4 and 5), 200 (FIGS. 6 and 7), and 300 (FIG. 8). As is clear from these embodiments the housings may include single piece and multiple piece housings, and may include conductive and nonconductive housing pieces.

Connecting terminals may also be provided in the method 50 as appropriate to complete the manufacture of a device, such as the devices 80, 120, 200, and 300 so that the storage cells, and specifically the electrodes of the storage cells in contemplated examples, may be connected to external circuitry on, for example, a circuit board.

The molecular sieves in the electrode composition provide for desirable cost savings and performance improvements in devices such as the devices 80, 120, 200, and 300 described below.

As a demonstration of such performance advantages, energy storage cells including 2% by solid weight molecular sieves were tested and compared to energy storage cells without the 2% by solid weight molecular sieves. That is, a storage cells having an electrode composition with 2% molecular sieve replacing activated carbon composition was fabricated and tested for comparison to a control group of storage cells having an electrode composition with 2% more activated carbon than cells above without molecular sieve. For testing purposes, electrodes were fabricated without the molecular sieves) for the control group having a diameter of about 7.5 mm and a thickness of about 0.57 mm, and electrodes were fabricated (with the molecular sieves) having a diameter of about 7.5 mm and a thickness of about 0.57 mm.

Specifically, accelerated age testing was performed at 70° C. with 2.7 V applied to the energy storage cells. During testing, the cells were taken out of oven chamber, discharged and then electrically tested at periodic intervals (e.g., 100, 250, 500, 1000 hours in this example). The electrical test consisted of charging the storage cells to about 2.7 V at 1.8 mA, holding the Voltage for about 30 min at 2.7 V, discharging energy from the storage cells at 1.8 mA to 0 V.

The following parameters were recorded during the electrical testing:

1. Injection current: Charging current at end of 2.7 V voltage hold

2. Direct Current Resistance (DCR): Calculated from voltage drop immediately upon discharge step divided by discharge current, R=V/I; and

3. Capacitance: Calculated between 80% and 40% full voltage, C=I*dt/dV.

Following the electrical test, the storage cells were tested for equivalent series resistance (ESR) at 1 kHz using (performed on Fluke PM6304). Averages of the recorded parameters for ten control storage cells (without the 2% by weight molecular sieves) and ten storage cells (with the 2% by weight molecular sieves) were obtained and are presented in Table 1 below.

TABLE 1

| CC Life Data, 2.7 V, 70 C. | | Control | 2 wt % Sieves |
|---|---|---|---|
| Capacitance (F) | Initial | 0.79 | 0.77 |
| | Final | 0.68 | 0.66 |
| | % Change | 86.1 | 85.7 |
| 1 kHz (Ohm) | Initial | 9.4 | 9.9 |
| | Final | 79.8 | 26.7 |
| | % Change | 848.9 | 269.7 |
| DCR (Ohm) | Initial | 13.1 | 13.4 |
| | Final | 39 | 27.9 |
| | % Change | 297.7 | 208.2 |
| 30 min Inflow current (uA) | Initial | 86.8 | 78 |
| | Final | 35.8 | 29.8 |
| | % Change | 41.2 | 38.2 |
| Thickness (mm) | Initial | 1.8 | 1.82 |
| | Final | 1.83 | 1.84 |
| | % Change | 101.84 | 100.88 |

Table 1 reveals that the storage cells including the molecular sieves perform with about the same capacitance and inflow current remains about the same as the control cells without the molecular sieves. Large benefits are seen, however, with significant reductions in 1 kHz ESR and DCR for the cells having the molecular sieves versus the control group cells not having the molecular sieves. Also, as shown in Table 1, storage cells having the molecular sieves are seen to exhibit less bulging (i.e., a reduced change in thickness of the cell) as a result of the test.

The molecular sieve techniques described above are generally applicable to the manufacture of energy storage devices such as electric double layer capacitor (EDLC) devices of different types. While the molecular sieve techniques are beneficial for the manufacture of ELDCs, such EDLCs are described for purposes of illustration rather than limitation. Other types of energy storage devices posing similar issues relating to water contamination of electrolyte, including but not necessarily limited to energy storage batteries, may likewise benefit from the storage cell manufacturing techniques incorporating molecular sieves. Moreover, insofar as the electrode techniques disclosed are applied to EDLC devices, they are broadly applicable to many possible variations of such devices. Accordingly, several non-limiting examples of EDLC devices are described below in relation to FIGS. 2 and 4-7.

FIG. 2 illustrates a first exemplary embodiment of an EDLC device 80. The device 80 generally includes a multi-piece housing including a first housing piece 82 and a second housing piece 84. The housing piece 82 is sometimes referred to as a case, and the housing 84 is sometimes referred to as a cap. In an exemplary embodiment the housing pieces 82 and 84 may be fabricated from stainless steel. A gasket 86 may interconnect the housing pieces 82 and 84, as well as provide a seal for the housing pieces 82 and 84 when assembled. When assembled, and in the example shown in FIG. 2, the device 80 has a coin cell configuration, although other configurations are possible in alternative embodiments.

As shown in FIG. 2, the housing pieces 82 and 84 collectively define an interior space or cavity that contains a single storage cell 88. The storage cell 88 is generally enclosed by the housing pieces 82 and 84. The storage cell 88 includes a first electrode 90 and a second electrode 92 extending on opposing sides of a separator 94. In use, one of the electrodes 90 and 92 serves as an anode and the other of the electrodes 90 and 92 serves as a cathode, depending on the polarity of the device 80 when connected to electrical circuitry. The construction and operation of the cell 88 in the EDLC device 80 is well understood and will not be detailed further herein, except in relation to the electrode composition including molecular sieves and related device fabrication techniques as described above.

FIG. 3 illustrates an exemplary method or process 100 of fabricating a device such as the device 80 shown in FIG. 2. The process 100 may be recognized as an adaptation of the method 50 shown in FIG. 1 to manufacture the device 80.

As shown in FIG. 3, the method 100 includes the step 52 of providing the electrode slurry (which may be obtained by steps 54, 56, 58 and 60 shown in FIG. 1), the step 62 of drying the slurry to obtain a powder, and the step 64 of compressing the powder to form a sheet of electrode material. As shown at step 102, first and second electrodes (90 and 92 shown in FIG. 2) are stamped form the sheet obtained at step 64.

At step 104 the first electrode (electrode 90 shown in FIG. 2) may be adhered to a first housing piece (the housing piece 82 shown in FIG. 2) with heat and pressure. As shown at step 106 the second electrode (electrode 92 shown in FIG. 2) may be adhered to a second housing (the housing piece 84 shown in FIG. 2) adhered with heat and pressure. The electrodes 90, 92 may be adhered to the housing pieces 82, 84 at steps 104 and 106, for example, with a conductive adhesive such as DAG EB-012 adhesive commercially available from Henkel Corporation, Madison Heights, Mich.

Once the electrodes 90, 92 are adhered to the housing pieces 82, 84 as shown at steps 104 and 106, the first and second electrodes 90, 92 may be dried at step 108. The drying step 108 may be performed, for example, at a temperature of about 110° C. under vacuum for a predetermined time such as twenty four hours.

As shown at step 110 a separator, such as the separator 94 shown in FIG. 2 may be placed on top of one of the electrodes 90, 92 and as shown at step 112 a gasket, such as the gasket 86 shown in FIG. 2, may be installed around one of the electrodes 90. 92 in the respective housing pieces 82 and 84. An electrolyte, such as IM Tetraethylammonium Tetrafluoroborate in Propylene Carbonate commercially available from Honeywell in one example, may then be added to both electrodes as shown at step 114. The device 80 may be completed in one example assembling the housing pieces 82, 84 by, for example, snapping the housing pieces 82, 84 together and crimping them shut.

The device 80 made by the process 100 results in a relatively simple and low cost EDLC device that may be manufactured efficiently and with reduced costs relative to conventional EDLC devices. Moreover, the device 80 fabricated by the process 100 provides superior performance to otherwise similar devices without the molecular sieves.

FIG. 4 illustrates a second exemplary embodiment of an energy storage device in the form of an EDLC device 120 also configured as a coin cell familiar to those in the art but having multiple storage cells therein.

The EDLC device 120 generally includes a housing assembled from a first conductive housing piece 122 and a second conductive housing piece 124 that, in the example shown in FIG. 4, collectively defines a coin cell package configuration as those in the art would recognize due to its resemblance in overall shape to a currency coin, such as a dime, for example. That is, the device 100 is provided in a disc-shaped or coin-shaped package.

One of the benefits of a coin cell configuration is its low profile. That is, the device 120, by virtue of the housings pieces 122 and 124 has a relatively small thickness yet a relatively wide surface area on the opposing sides of the device 120. More specifically, and as used herein, a “low-profile” device has a first dimension that is substantially smaller than a second and third dimension in an orthogonal coordinate system. That is, considering a Cartesian coordinate system having axes x, y, and z as shown in FIG. 4, the x axis may correspond to a length dimension of the device 120, the y axis may correspond to a width dimension of the device 120, and the z dimension may correspond to the height or thickness dimension of the device 120. In the exemplary device shown, the thickness dimension z is much less than either the length or width dimensions x or y.

The thickness dimension z is typically rather small and is measured in millimeters. As one non-limiting example, the ELDC device 120 may have an overall diameter, measured in the x, y, plane on the order of about 25 mm and a thickness dimension on the order of about 5 mm or less. Various other dimensions, both greater and smaller, are possible. Various dimensions may be provided to produce package sizes comparable to conventional coin cell batteries, applicable standards, or to meet user defined specifications. Advantageously, the small thickness dimension z provides a low-profile height that facilitates installation of the device 120 in a slim electronic device, for example.

Each housing piece 122 and 124 defines a respective and generally circular contact area 123, 125 for connection to corresponding electrical terminals of circuitry. The circuitry may be established on a circuit board 121 (shown in phantom in FIG. 4) in an exemplary embodiment. The contact areas 123, 125 of the device 120 are spaced apart and extend opposite one another in the device 120, and the area 123, for example, may lie in surface engagement with a first terminal pad formed on a surface of a circuit board 121. A power terminal, provided on and extending from the board 121, contacts the area 125, or perhaps contacts the periphery of the housing 124 surrounding the contact area 125, to complete the circuit through the EDLC device 120. The low profile of the EDLC device 120, measured in the z dimension extending perpendicular to the major surfaces of the board 121, facilitates a slim electronic device including the board 121. The board 121 may be configured to accommodate a single EDLC device 120 or multiple devices 120 depending on end use requirements.

In the exemplary EDLC device 120, the diameter of the contact area 123, 125 (also shown in FIG. 5) corresponding to each housing piece 122 and 124 is different. More specifically, the contact area 123 of the housing piece 122 has a larger diameter than the contact area 125 of the housing piece 124. The contact area 125 is further inset in the device 120 or spaced from the outer periphery of the overall device in the x, y plane. These features of the contact areas 123, 125 may be coordinated with the connecting terminals of the circuit board 121 to ensure that the device 120 is installed with the proper polarity in use. In other words, the connecting terminals may be configured to accept the EDLC device 120 in only one orientation. Alternatively stated, the dimensions of the housing pieces 122, 124 and the connecting terminals may be selected so that the EDLC device 120 can only be installed right-side up and any attempt to install the device 120 upside down will be frustrated. Undesirable reverse current flow through the device 120 due to improper installation is therefore avoided.

In use, one of the housing pieces 122 and 124 may be connected to a positive, line-side terminal of the board 121 and the other of the housing pieces 122 and 124 may be connected to a negative, load-side terminal of the board 121, with the device 120 completing an electrical connection between the positive and negative terminals. As current flows from the positive terminal to the negative terminal through the ELDC device 120 when so connected, energy is stored in the device 120 and accordingly may be discharged from the device 120 when needed.

The housing pieces 122, 124 may each be formed from electrically conductive metals or metal alloys, including but not limited to limited to stainless steel, in exemplary embodiments using known techniques.

Unlike the device 80 (FIG. 2), the EDLC device 120 includes multiple storage cells that are electrically connected in series internal to the housing of the device 120. The series connected storage cells in the device 120 allows the EDLC device 120 to operate at higher voltages than is otherwise possible with a single cell device. As such, the EDLC device 120 is operable with higher voltage drops between the polarized housing pieces 122 and 124.

The higher operating voltage capabilities of the EDLC device 120 also allows for a reduction in the number of EDLC devices required for certain installations, leading to space savings and simplified energy storage circuitry. The EDLC device 120 may be used in place of two single cell EDLC devices 80 with a much smaller package size than two single cell devices each contained in separate housings, but used in combination. The size of the circuit board 121 may accordingly be reduced to provide even smaller electronic devices. Costs of providing energy storage systems may accordingly be reduced, and reliability of the energy storage system may be increased. More powerful, yet smaller and lower cost energy storage systems, are therefore possible.

Turning now to FIG. 5, the internal construction of the exemplary EDLC device 120 is shown in sectional view. The device 120 includes, as shown in FIG. 5, a first storage cell 126, a sealing conductor 128, a second storage cell 130 and a sealing insulator 132. The storage cells 126 and 130, the sealing conductor 128, and the sealing insulator 132 are generally enclosed by the conductive housing pieces 122, 124. The housing pieces 122 and 124 collectively define an interior cavity that accommodates the cells 126 and 130, the sealing conductor 128 and the insulator 132.

The first storage cell 126 is positioned adjacent to and in contact with the housing piece 122 opposite the contact area 123. The first storage cell 126 includes electrodes 134 and 136 extending on opposing sides of a separator 140. In use, one of the electrodes 134 and 136 serves as an anode and the other of the electrodes 134 and 136 serves as a cathode, depending on the polarity of the device 120 when connected to electrical circuitry. The construction and operation of the cell 126 in the EDLC device 120 is well understood and will not be detailed further herein, except in relation to the electrode composition including molecular sieves and related device fabrication techniques as described above.

The sealing conductor 128 in the exemplary embodiment shown includes a generally flat end wall 142, a generally cylindrical side wall 144 extending from the end wall 142, and a sealing rim or flange 146 extending outwardly from the side wall 144. The end wall 142 overlies and is in contact with electrode 136 of the first storage cell 126 and has a diameter that is larger than the storage cell 126, such that the cylindrical side wall 144 generally surrounds the periphery or circumference of the first cell 126. That is the end walls 142 and the side wall 144 generally define an enclosure extending above the housing 122 that contains the first cell 126. The sealing rim 146 extends parallel to, but in a plane spaced from the end wall 142. That is, the side wall 144 interconnects the end wall 142 and the sealing rim 146 with the wall 142 and the rim 146 extending from opposing ends of the side wall 144. The sealing rim 146 is annular and has an outer diameter larger than the end wall 142 and the side wall 144. The sealing conductor 128 may be formed from a conductive material known in the art according to known techniques.

The second storage cell 130 extends adjacent to and in contact with the end wall 142 of the sealing conductor 128. The second storage cell 130 includes electrodes 148 and 150 extending on opposing sides of a separator 152. In use, one of the electrodes 148 and 150 serves as an anode and the other of the electrodes 148 and 150 serves as a cathode, depending on the polarity of the device 120 as connected to electrical circuitry. The construction and operation of the cell 120 in the EDLC device 120 is well understood and will not be detailed further herein. In an exemplary embodiment, the cell 130 is constructed substantially identically to the cell 126, although it is contemplated that the cells 126 and 130 could be constructed differently if desired. That is, the cells 126 and 130 may or may not include the same types of electrodes or separators in various embodiments of the device 11s0.

The end wall 142 of the sealing conductor 128 electrically connects the storage cells 126 and 130 in series with one another, while isolating ion movement between the cells 126 and 130 in operation. That is, the sealing conductor 128 separates the storage cells 126, 130 such that ions are prevented from moving from one cell 126 to the other 130 or vice-versa, but the sealing conductor 128 nonetheless provides a conductive path between the cells 126 and 130. As such, and as one example, current may flow from the housing piece 122 to and through the first storage cell 126, from the first storage cell 126 to and through the sealing conductor 128, from the sealing conductor 128 to and through the second storage cell 130, and from the second storage cell 130 to and through the housing piece 204. Via the storage cells 126 and 130, energy is stored in the device 120 and can be discharged when the voltage potential across the housing pieces 122 and 124 drops below a predetermined threshold. As such, the EDLC device 120 both stores and dissipates energy in response to actual operating conditions in a circuit. The sealing conductor 128 may be fabricated utilizing known techniques and suitable conductive materials in the art, including but not necessarily limited to metallic materials, conductive polymers, and conductive composite materials.

The sealing insulator 132 is coupled to a portion of the sealing conductor 128. In the illustrated embodiment, the sealing insulator 132 is in contact with and generally surrounds the side wall 144 of the sealing conductor 128. Additionally, the sealing insulator 142 is formed with an annular slot that receives and is engaged with the sealing rim 146 of the sealing conductor 128.

As also shown in FIG. 5 the sealing insulator 132 is configured to mechanically interconnect the first and second housing pieces 122 and 124. An outer periphery 154 of the housing 124 extends to and is received in an interior area or cavity 156 of the sealing insulator 132, while an outer periphery 156 of the housing 122 wraps around the exterior of the sealing insulator 132. The sealing insulator 132 therefore extends between and electrically isolates the housing piece 122 from the housing piece 124 on the interior as well as the exterior of the device 120. The sealing insulator 132 as shown further mechanically interconnects, but electrically isolates, the sealing conductor 128 from both of the housing pieces 122 and 124. That is, a portion of the sealing insulator 132 extends between the housing 122 and the sealing rim 146 of the sealing conductor 128, another portion of the sealing insulator 132 extends between the sealing rim 146 and the outer periphery of the housing piece 124, and still another portions of the sealing conductor 132 extends between the cylindrical side wall 144 of the sealing conductor 128 and the outer periphery of the housing piece 124. The sealing insulator 132 may be fabricated utilizing known techniques and suitable materials in the art, including but not necessarily limited to nonconductive metal oxide and nonconductive polymer materials.

While two storage cells 126 and 130 are shown in the illustrated embodiment of FIGS. 4 and 5, more than two cells could be provided, although it is understood that additional sealing conductors 128 and insulators 122 may be required to accommodate additional cells.

FIGS. 6 and 7 illustrate a third exemplary embodiment of an EDLC device 200. The device 200 generally includes a nonconductive housing 202 generally shaped as a cylinder and having an interior cavity that contains a first storage cell 206, a sealing conductor 208, and a second storage cell 210. The storage cells 106 and 108 and the sealing conductor 108 are generally enclosed by the housing 202, which may be formed in more than one part or as a single part in various embodiments. The housing 202 may be formed from electrically nonconductive materials known in the art, such as plastic for example, according to known techniques and processes, including but not limited to molding. While a rounded cylindrical shape of the housing is illustrated, other shapes are possible and may be utilized, including but not limited to square or rectangular shapes.

The first storage cell 206 is positioned adjacent to and in contact with the housing 202 on one side of the device 200. The first storage cell 206 includes electrodes 214 and 216 extending on opposing sides of a separator 220. In use, one of the electrodes 214 and 216 serves as an anode and the other of the electrodes 214 and 216 serves as a cathode, depending on the polarity of the device 200 when connected to electrical circuitry. The construction and operation of the cell 206 in the EDLC device 100 is well understood and will not be detailed further herein, except in relation to the electrode composition including molecular sieves and related device fabrication techniques described above.

The sealing conductor 208 in the exemplary embodiment shown is generally flat and planar and has a disc-shape. Alternatively stated, the sealing conductor 208 is formed as a generally circular, flat plate in the exemplary embodiment shown, although other shapes are possible in other embodiments. The shape of the sealing conductor 208 is therefore greatly simplified compared to the sealing conductor 128 (FIG. 5) in the device 120. The sealing conductor 208 may be formed from a suitable conductive material, such as those described above for the sealing conductor 108 in the device 100, according to known techniques.

The sealing conductor 208 electrically connects the storage cells 206 and 210 in series with one another, while isolating ion movement between the cells 206 and 210 in operation. That is, the sealing conductor 208 separates the storage cells 206, 210 such that ions are prevented from moving from one cell 206 to the other 210 or vice-versa, but the sealing conductor 208 nonetheless provides a conductive path between the cells 206 and 210. As best shown in FIG. 3, a peripheral edge of the sealing conductor 208 may extend into a side wall of the housing 202 to completely seal and partition the housing cavity between the storage cells 206, 210. That is, a radial dimension of the sealing conductor 208 in the example shown is greater than the inner radius of the housing 202 such that the housing sidewall 204 surrounds the peripheral edge 222 of the sealing conductor 208.

The second storage cell 210 extends adjacent to and in contact with the sealing conductor 208 opposite the first storage cell 206. The second storage cell 210 includes electrodes 228 and 230 extending on opposing sides of a separator 232. In use, one of the electrodes 228 and 230 serves as an anode and the other of the electrodes 228 and 230 serves as a cathode, depending on the polarity of the device 200 as connected to electrical circuitry. The construction and operation of the cell 210 in the EDLC device 200 is well understood and will not be detailed further herein, with the exception of the molecular sieve concepts described above. In an exemplary embodiment, the cell 210 is constructed substantially identically to the cell 206, although it is contemplated that the cells 206 and 210 could be constructed differently if desired. That is, the cells 206 and 210 may or may not include the same types of electrodes or separators in various embodiments of the device 200.

Conductive terminal elements 234 and 236 are also provided that respective contact the first cell 206 and the second cell 210. The terminal elements 234 and 236 include generally circular contact areas adjacent to the respective electrodes 214 and 230 of the cells 206 and 210. The terminals 234 and 236 may be formed from as conductive metal plates, and in the example shown may include elongated connector sections 238, 240 that may be used to connect the device 200 to electrical circuitry in a known manner.

The insulating housing 202 electrically isolates the terminal elements 234 and 236 from one another, while the sealing conductor 208 connects the storage cells 206 and 208 between the terminal elements 234 and 236. In the example shown, only the connector sections 238, 240 of the elements 234 and 236 are exposed externally to the housing 202.

The insulating housing 202 eliminates a need for the sealing insulator 132 (FIGS. 4 and 5) in the device 200. The sealing conductor 208 is also greatly simplified in comparison to the sealing conductor 128 (FIGS. 4 and 5) in the device 120. The terminal elements 202, 204 are much more easily formed than the metal housing pieces 122, 124 in the device 120. The device 200 therefore provides a number of manufacturing advantages in relation to the device 100, including elimination of certain parts and simplification of other parts.

Operating voltages of up to about 5.5 V are possible using the devices 120 and 200, as compared to operating voltages of about 2.5 V to about 2.7 V for conventional EDLC devices. The increased operating voltage in a single device package is beneficial for the reasons noted above.

FIG. 8 is a sectional view of a fourth exemplary embodiment of an electrochemical energy storage device 300 including a housing 302, and at least one energy storage cell 303 in the housing 302. When the housing 302 is filled with an electrolyte to impregnate the storage cell 303, the storage cell is operable to store and release electrical energy to and from an external electrical circuit. The device 300 also includes a cap 304 coupled to the housing 302 and the cap 304 includes first and second metal terminal lugs 306 and 308.

The housing 402 in the example depicted in FIG. 8 is a generally elongated cylindrical element having a first end 310, a second end 312 opposite the first end, and a cylindrical sidewall 314 extending between the first end 310 and the second end 312. The first end 310 is generally flat and planar, and the second end 312 is attached to the cap 404. The sidewall 314 between the first and second ends 310, 312 is generally round in cross section and has a constant diameter for most of its axial length measured between the first and second ends 310, 312. The housing 402 includes a restricted section 316 wherein the sidewall 314 is folded to facilitate connection of the cap 404 and sealing of the storage cell 403.

The storage cell 403, as shown in FIG. 8, extends in a receptacle in the housing 402 defined between the housing first end 310, the sidewall 314 and the restricted section 316. The housing 402 in exemplary embodiments may be formed from metal, such as steel or aluminum in exemplary embodiments, using known techniques. The housing 402 is often referred to as a can. In contemplated embodiments, the can 402 is fabricated from metal, including but not limited to steel or aluminum, in a known manner.

The at least one storage cell 403 of the ELDC device 400 is situated internal to the receptacle defined by the housing 402 as shown. As the device 400 is manufactured, the storage cell 403 is filled with an electrolyte and the storage cell 403 includes a positive electrode (cathode), a negative electrode (anode), and a separator such as a membrane that separates the anode space from the cathode space. The storage cell 403 may be provided as a generally tubular or cylindrical jelly roll having multiple layers (electrode layers and separator layers) that define a single cell or multiple cells. It is recognized that a jelly roll may alternatively be provided in other shapes and configurations, including but not limited to folded configurations and accordion shapes if desired. One or more current collectors (not shown) may also be provided to the jelly roll to interconnect the anode(s) and the electrodes(s) of the storage cell(s) 403. The metal terminal lugs 306, 308 provide respective electrical connection between the anode(s) of the storage cell(s) 403 and the cathode(s) of the energy storage cell(s) and external electrical circuitry.

The construction and operation of the storage cell 403 in the housing 402 of the EDLC device 400 is well understood and will not be detailed further herein, expect except in relation to the electrode composition including molecular sieves and related device fabrication techniques described above.

While a number of exemplary devices 80, 120, 200 and 300 having electrodes formed with molecular sieves are described, still other devices are possible. It is also contemplated that while all of the embodiments described thus far include electrodes fabricated to include the molecular sieves as described, other elements of the storage cells and/or associated devices may be fabricated to include molecular sieves in lieu of the terminals. For example, in embodiments of devices having electrodes and current collectors, the electrode slurry described above could be utilized to fabricate the current collectors of the device with similar effect. As another example, the electrode slurry described above may be used to coat elements, such as electrodes and current collectors, that do not themselves include molecular sieves while achieving at least some of the benefits described.

The benefits and advantages of the inventive concepts are now believed to evident in view of the exemplary embodiments disclosed.

An embodiment of an electrochemical energy storage device has been disclosed. The device includes at least one electrochemical energy storage cell. The at least one electrochemical storage cell includes an electrolyte; and at least one element fabricated from compressed powder, the compressed powder including molecular sieves selected to allow passage of a contaminant from the electrolyte.

Optionally, the compressed powder may include more than 60% active carbon by solid weight. The compressed powder may include less than 20% conductive carbon by solid weight. The compressed powder may include more than 1% binder by solid weight. The compressed powder may include less than 5% molecular sieves by solid weight. The molecular sieves may have a pore size of about 3 Angstroms. The at least one element may be one of an electrode and a current collector.

The at least one electrochemical energy storage cell may include a first storage cell and a second storage cell, with each of the first storage cell and the second storage cell including at least one element fabricated from compressed powder, the compressed powder including molecular sieves. The energy storage device may also include a housing, with the housing containing the at least one storage cell. The housing may include a first housing piece and a second housing piece. The first and second housing pieces may be configured with a coin cell configuration. The housing may be electrically conductive.

The energy storage device may also include first and second terminal elements configured to connect the at least one energy storage cell to an external circuit. The housing may include a first end and a second end opposing the first end, with each of the first and second terminal elements extending on the first end. The first and second terminal elements may include metal lugs.

The device may be one of an electric double layer capacitor (EDLC) device and a battery.

An exemplary method of manufacturing an electrochemical energy storage device has also been disclosed. The device includes: providing at least one carbon-based element comprising molecular sieves; and adding an electrolyte to the carbon-based element.

Providing the at least one carbon based element may include obtaining an electrode slurry including the molecular sieves; drying the slurry to obtain a powder; and compressing the powder. Drying the slurry to obtain the powder may include obtaining a powder comprising more than 60% active carbon by solid weight. Drying the slurry to obtain the powder may include obtaining a powder having less than 20% conductive carbon by solid weight. Drying the slurry to obtain the powder may include obtaining a powder comprising a binder more than 1% by solid weight. Drying the slurry to obtain the powder may include obtaining a powder comprising less than 5% molecular sieves by solid weight. Obtaining the electrode slurry may include obtaining an electrode slurry having molecular sieves with a pore size of about 3 Angstroms.

An energy storage element device may be formed by the process. The device may be configured with a coin cell configuration. The device may be one of an electric double layer capacitor (EDLC) device and a battery.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electrochemical energy storage device comprising:
at least one electrochemical energy storage cell, the at least one electrochemical storage cell comprising:
an electrolyte; and
at least one element fabricated from compressed powder, the compressed powder including molecular sieves selected to allow passage of a contaminant from the electrolyte.

2. The energy storage device of claim 1, wherein the compressed powder comprises more than 60% active carbon by solid weight.

3. The energy storage device of claim 1, wherein the compressed powder comprises less than 20% conductive carbon by solid weight.

4. The energy storage device of claim 1, wherein the compressed powder comprises more than 1% binder by solid weight.

5. The energy storage device of claim 1, wherein the compressed powder comprises less than 5% molecular sieves by solid weight.

6. The energy storage device of claim 1, wherein the molecular sieves has a pore size of about 3 Angstroms.

7. The energy storage device of claim 1, wherein the at least one element comprises one of an electrode and a current collector.

8. The energy storage device of claim 1, wherein the at least one electrochemical energy storage cell comprises a first storage cell and a second storage cell, each of the first storage cell and the second storage cell including at least one element fabricated from compressed powder, the compressed powder including molecular sieves.

9. The energy storage device of claim 1, further comprising a housing, and the housing containing the at least one storage cell.

10. The energy storage device of claim 9, wherein the housing comprises a first housing piece and a second housing piece.

11. The energy storage device of claim 10, wherein the first and second housing pieces are configured with a coin cell configuration.

12. The energy storage device of claim 9, wherein the housing is electrically conductive.

13. The energy storage device of claim 9, further comprising first and second terminal elements configured to connect the at least one energy storage cell to an external circuit.

14. The energy storage device of claim 13, wherein the housing has a first end and a second end opposing the first end, each of the first and second terminal elements extending on the first end.

15. The energy storage device of claim 14, wherein the first and second terminal elements comprise metal lugs.

16. The energy storage device of claim 1, wherein the device is one of an electric double layer capacitor (EDLC) device and a battery.

17. A method of manufacturing an electrochemical energy storage device, the method comprising:
providing at least one carbon-based element comprising molecular sieves; and
adding an electrolyte to the carbon-based element.

18. The method of claim 17, wherein providing the at least one carbon based element includes:
obtaining an electrode slurry including the molecular sieves;
drying the slurry to obtain a powder; and
compressing the powder.

19. The method of claim 18, wherein drying the slurry to obtain the powder comprises obtaining a powder comprising more than 60% active carbon by solid weight.

20. The method of claim 18, wherein drying the slurry to obtain the powder comprises obtaining a powder comprising less than 20% conductive carbon by solid weight.

21. The method of claim 18, wherein drying the slurry to obtain the powder comprises obtaining a powder comprising a binder more than 1% by solid weight.

22. The method of claim 18, wherein drying the slurry to obtain the powder comprises obtaining a powder comprising less than 5% molecular sieves by solid weight.

23. The method of claim 18, wherein obtaining the electrode slurry comprises obtaining an electrode slurry having molecular sieves with a pore size of about 3 Angstroms.

24. An energy storage element device formed by the process of claim 17.

25. The energy storage element of claim 24, wherein the device is configured with a coin cell configuration.

26. The energy storage device of claim 25, wherein the device is one of an electric double layer capacitor (EDLC) device and a battery.
